(19) United States
(12) Patent Application Publication
(10) Pub. No.: US 2007/0014945 A1
(43) Pub. Date: Jan. 18, 2007

(54) Guidewire with varied lubricity

(75) Inventors: Horng-Ban Lin, Maple Grove, MN (US); James G. Hansen, Coon Rapids, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: Boston Scientific Scimed, Inc.

(21) Appl. No.: 11/179,290

(22) Filed: Jul. 12, 2005

(51) Int. Cl. B32B 1/08

(52) U.S. Cl. 428/34.1

(57) ABSTRACT

Medical devices and methods for manufacturing the same. An example medical device includes a shaft or substrate that is coated with a lubricious coating. The coating includes a plurality of sections that have differing lubricities. At least some of the sections include a hydrophilic polyurethane. A coated section can include an aliphatic polyether polyurethane. The methods for manufacturing the medical devices may include at least in part microdispensing such as inkjet-type printing.

### FIELD OF THE INVENTION

The invention relates to intracorporeal medical devices, for example, intravascular guidewires, catheters, stents, and the like as well as improved methods for manufacturing medical devices. More particularly, the invention relates to medical devices that are coated with a lubricious coating.

### BACKGROUND

A wide variety of medical devices have been developed for medical use, for example, intravascular use. Some of these devices include guidewires, catheters, stents, and the like that have a lubricious coating. These devices are manufactured by any one of a variety of different manufacturing methods. Of the known medical devices and manufacturing methods, each has certain advantages and disadvantages. There is an ongoing need to provide alternative medical devices as well as alternative methods for manufacturing medical devices.

### BRIEF SUMMARY

The invention provides design, material, and manufacturing method alternatives for medical devices. Exemplary medical devices include a shaft or substrate that is coated with a lubricious coating. At least a portion of the shaft having a lubricious coating includes a plurality of coated sections that have differing lubricities. At least one of the sections includes a hydrophilic polyurethane. In some preferred embodiments a coated section includes an aliphatic polyether polyurethane. The methods for manufacturing the medical devices include at least in part microdispensing, such as inkjet-type printing.

The above summary of some embodiments is not intended to describe each disclosed embodiment or every implementation of the present invention. The Figures, and Detailed Description, which follow, more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is side view of an example catheter and guidewire disposed within a blood vessel;

FIG. 2 is a side view of an example medical device;

FIG. 3 is a side view of another example medical device;

FIG. 4 is a side view depicting a coating being applied to a shaft or substrate;

FIG. 5 is a side view depicting another coating section being applied to the substrate depicted in FIG. 4; and

FIG. 6 is a side view depicting another coating section being applied to the substrate depicted in FIG. 5.

### DETAILED DESCRIPTION

The following description should be read with reference to the drawings wherein like reference numerals indicate like elements throughout the several views. The detailed description and drawings illustrate example embodiments of the claimed invention.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The drawings, which are not necessarily to scale, depict illustrative embodiments and are not intended to limit the scope of the invention.

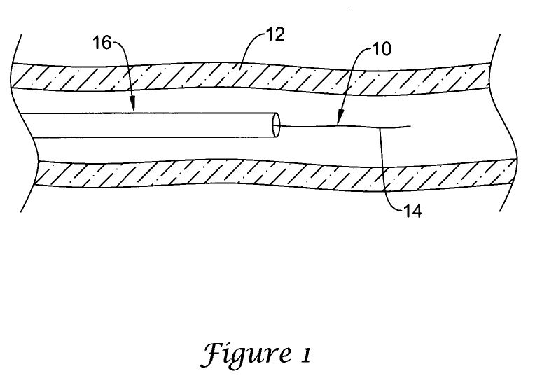

FIG. 1 is a plan view of an example guidewire 10 disposed in a blood vessel 12. Guidewire 10 may include a distal section 14 that may be, as is well known in the art, generally configured for probing deep within the anatomy of a patient. Guidewire 10 may be used for intravascular procedures according to common practice and procedure. For example, guidewire 10 may be used in conjunction with another medical device such as a catheter 16. Of course, numerous other uses are known amongst clinicians for guidewires and other similarly configured medical devices.

Because many medical devices are designed to function within the vasculature, it is often desirable to coat the medical devices with a coating, for example, that is lubricious, hydrophilic, protective, and/or the like. Lubricious coatings have a lower coefficient of friction than other non-lubricious or less lubricous materials. This gives lubricious materials or coatings a smooth, slippery feel that is desirable for some applications. Accordingly, a lubricious coating can improve device handling, exchanges and steerability, and improve lesion crossing capability. Although coatings are typically associated with intravascular guidewires and catheters, such as the ones schematically represented in FIG. 1, essentially any medical device may benefit from a coating. It can be appreciated that the device could be any intravascular device or be any device designed to pass through or be disposed in an opening or body lumen. For example, the device may comprise any type of guidewire, catheter (e.g., therapeutic, diagnostic, or guide catheter), endoscopic device, laproscopic device, stent or stent-associated device, embolic protection device, or any other suitable device.

Suitable lubricious polymers are well known in the art and may include silicone high-density polyethylene (HDPE), polytetrafluoroethylene (PTFE), polyarylene oxides, polyvinylpyrolidones, polyvinylalcohols, hydroxy alkyl cellulosics, algins, saccharides, caprolactones, and the like, and mixtures and combinations thereof. Hydrophilic polymers may be blended among themselves or with formulated amounts of water insoluble compounds (including some polymers) to yield coatings with suitable lubricity, bonding, and solubility. Some other examples of such coatings and materials and methods used to create such coatings can be found in U.S. Pat. Nos. 6,139,510 and 5,772,609, the disclosures of which are incorporated herein by reference.

In addition to the above list of lubricious coatings, one preferred coating includes a hydrophilic polyurethane, preferably in some embodiments an aliphatic polyether polyurethane, coated on any of the example medical devices. One advantage of this class of coatings is that lubricity of a given coating may be adjustable by changing the polymer coating composition. Accordingly, the degree of lubricity can be tailored to suit the needs of a particular device. Some examples of commercially available aliphatic polyether polyurethanes include TECOGEL® (manufactured by Thermedics Polymer Products, Wilmington, Mass.), HYDROSLIP® (manufactured by CardioTech International, Inc., Woburn, Mass.), and HYDROMER® (manufactured by Hydromer, Inc., Branchburg, N.J.). Some further discussion regarding this class of polymers can be found in U.S. Pat. Publication No. 2005/0054774, the entire disclosure of which is herein incorporated by reference.

Adjustment of the polymer coating composition may occur at the manufacturer level and be embodied by a variety of different commercially-available forms of a given aliphatic polyether polyurethane. TECOGEL®, for example, is commercially available in a variety of lubricities which are characterized by the amount of its own weight that a given polymer can absorb in water. For example, TECOGEL® 200 is a commercially available form of TECOGEL® that is capable of absorbing 200% of its weight in water. Similarly available are TECOGEL® 500, which is capable of absorbing 500% of its weight in water, and TECOGEL® 2000, which is capable of absorbing 2000% of its weight in water. Other TECOGEL® polymers can be engineered with water absorption less than 200% and more than 2000% and could be utilized with the present invention for specific applications. When these polymers are used as coatings, they exhibit different lubricities (TECOGEL® 2000>TECOGEL® 500>TECOGEL® 200).

Another advantage of aliphatic polyether polyurethanes is their ease in preparation and use. For example, TECOGEL®, HYDROSLIP®, and HYDROMER® are readily dissolved in a mixture of water and isopropanol or a mixture of water and ethanol. Some of the other lubricious coating materials that are commonly used in conjunction with medical devices are dissolved in harsh organic solvents, which may be undesirable. Because aliphatic polyether polyurethanes are dissolvable in less harsh solvents, they are operation friendly and exhibit excellent compatibility with each other due to the similarity in their chemical structure.

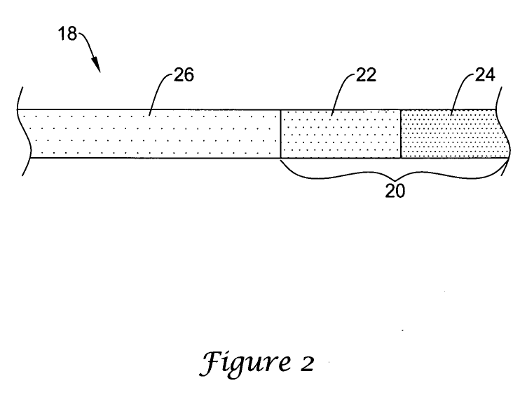

The use of aliphatic polyether polyurethane coatings on a medical device is illustrated in FIG. 2. Shown is a shaft (e.g., a guidewire shaft or core wire, a catheter shaft, etc.) or medical device substrate (e.g., a stent, a filter, etc.) 18. A lubricious coating or coating region 20 is disposed on shaft 18, for example, at its distal portion. The lubricious coating 20 may include a plurality of sections. For example, lubricious coating 20 includes a first section 22 and a second section 24.

In at least some embodiments, first section 22 and second section 24 have different lubricities. This may be due to the use of different aliphatic polyether polyurethanes in each of the sections 22/24. For example, first section 22 may include TECOGEL® 200 and second section 24 may include TECOGEL® 500. Alternative arrangements are contemplated such as first section 22 including TECOGEL® 200 and second section 24 including TECOGEL® 2000 and first section 22 including TECOGEL® 500 and second section 24 including TECOGEL® 2000. These arrangements render the more distal section (in this case second section 24) more lubricious than the immediately proximal section (in this case first section 22). Of course, the reverse arrangement is also contemplated and considered within the spirit and scope of the invention.

Sections 22/24 may also include a radiopaque filler material. Radiopaque filler materials are understood to be materials capable of producing a relatively bright image on a fluoroscopy screen or another imaging technique during a medical procedure. This relatively bright image aids the user of shaft 18 in determining its location within the body. Some examples of radiopaque materials can include, but are not limited to, gold, platinum, molybdenum, palladium, tantalum, tungsten or tungsten alloy, and the like. In some embodiments, a differing level of radiopaque materials can be utilized for sections 22/24. For example, first section 22 may have a first level of radiopaque filler material and second section 24 may include a second level, different from the first. The first level may be more or less than the second level or either of the section 22/24 may be free from radiopaque filler material.

The precise arrangement and configuration of first section 22 and second section 24 may vary. For example, the aliphatic polyether polyurethane used to define first section 22 may be disposed on shaft 18 so that it spans coating region 20. Subsequent to disposing first section 22 on coating region 20, the aliphatic polyether polyurethane used to define second section 24 may be disposed over the relevant portion of coating region 20 and over a portion of the polymer used to define first section 22. Thus, second section 24 may be multi-layered with the outermost layer being made from the particular aliphatic polyether polyurethane (i.e., the aliphatic polyether polyurethane having the desired level of lubricity) defining second section 24 and the inner-most layer being made from the particular aliphatic polyether polyurethane used to define first section 22.

The thickness of coating region 20 (and/or sections 22/24) can vary. For example, in some embodiments, first section 22 and second section 24 can be about 1-5 μm. This can be true even if one of the sections 22/24 is multi-layered. For example, the sum of the thicknesses for each layer may be less than about 1 μm to about 15 μm, preferably about 1 μm to about 5 μm. Alternatively, each of the layers may be about 1-5 μm so that the multi-layered section can have a thickness corresponding to the number of 1-5 μm layers.

The relative length of coating region 20 as well as the lengths of first section 22 and second section 24 can also vary. For example, some embodiments of coating region 20 can be about 1-50 cm. According to these embodiments, coating region 20 may be disposed near the distal end of shaft 18. This may leave a proximal section 26 of shaft 18 free from an aliphatic polyether polyurethane. Instead, proximal section 26 may be coated with another material or otherwise be “uncoated”. Other embodiments include longer versions of coating region 20, which may span essentially the entire length of shaft 18, including proximal section 26. In some of these embodiments, first section 22 may extend onto and coat proximal section 26.

The length of first section 22 and second section 24 may be about 1-50 cm each. For example, some embodiments include first section 22 that is about 20-30 cm and second section 24 that is about 1-10 cm. Of course, any appropriate combination of lengths can be utilized without departing from the spirit of the invention.

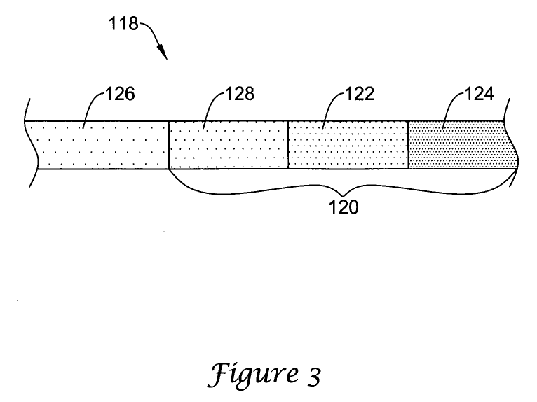

FIG. 3 illustrates another example shaft or substrate 118 with coating region 120. Coating region 120 includes a third section 128 in addition to first section 122 and second section 124. In some embodiments, each of the three sections 122/124/128 may include a different aliphatic polyether polyurethane. Each of the aliphatic polyether polyurethanes can have a different lubricity. For example, third section 128 may include TECOGEL® 200, first section 122 may include TECOGEL® 500, and second section 124 may include TECOGEL® 2000. Any other suitable combination of aliphatic polyether polyurethanes may be utilized. Similar to the medical device in FIG. 2, shaft 118 may also include proximal section 126, which may or may not be coated. All of the above discussion related to the arrangement, configuration, thickness, etc. of analogous sections can be applied to sections 122/124/126/128, to the extent applicable.

Another aspect of the invention is related to the methods that can be used to coat a shaft or medical-device substrate. In some embodiments, the aliphatic polyether polyurethane can be solublized (e.g., in a water/isopropanol or water/ethanol mixture as described above) so that the aliphatic polyether polyurethane can be dip coated or spray coated onto the shaft or substrate. Accordingly, any of the above shafts can be coated utilizing these steps. For example, third section 128 can be defined by dip coating or spray coating an aliphatic polyether polyurethane onto shaft 118. Subsequent dip coating or spray coating steps can be utilized to apply the remaining aliphatic polyether polyurethane sections 122/124.

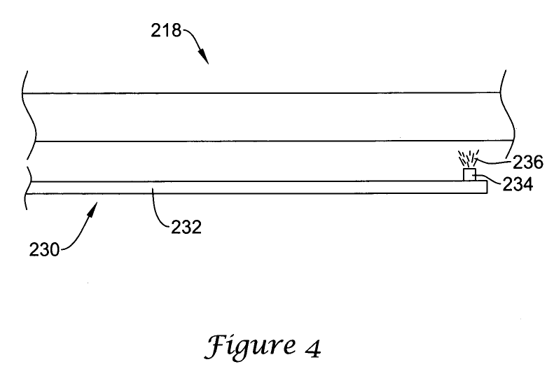

FIGS. 4-6 illustrate a microdispensing method that can be utilized to apply aliphatic polyether polyurethane onto shaft or substrate 218. Microdispensing is defined as a method for precisely applying a material to a substrate much like how a typical inkjet printer applies ink to paper. In order to coat shaft 218, a microdispensing apparatus 230 can be positioned adjacent shaft 218. The appropriate aliphatic polyether polyurethane can be passed through a supply tube 232 and out from a nozzle or jet 234 in a spray 236.

In some embodiments, the spray 236 may resemble a number of polymeric droplets. This type of coating technique is analogous to inkjet printing. Microdispensing that is similar to or essentially the same as inkjet printing may be desirable due to the precision in which inkjet-deposited material can be placed onto shaft 218. For example, inkjet technology allows for relatively small volumes to be transferred (e.g., on the order of a picoliter) and for relatively small droplets of aliphatic polyether polyurethane (e.g., on the order of 4-75 μm, preferably 4-25 μm). This can provide for relatively thin layers (e.g., on the order of less than 1 μm to 15 μm, preferably about 1-15 μm) of aliphatic polyether polyurethane to be applied to shaft 218. When coating, nozzle 234 may be moved in any direction relative to shaft 218 and/or shaft 218 may be rotated or moved relative to nozzle 234. Again, this allows for great precision in the application of the coating.

In addition to the features described above, microdispensing also allows for multiple coatings to be applied simultaneously. For example, microdispensing apparatus may include one or more additional supply tubes 232 and/or one or more additional nozzles 234. According to this embodiment, different sections of coating region 220 can be defined at the same time. This may save manufacturing time and resources.

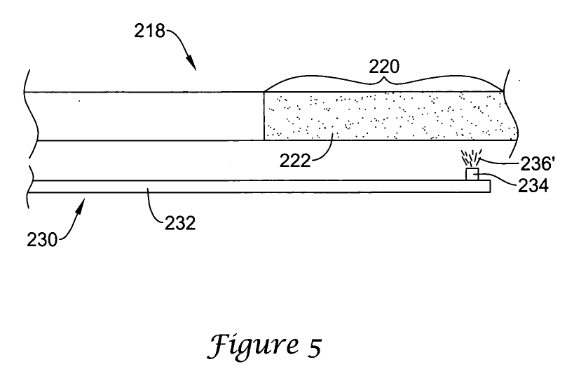

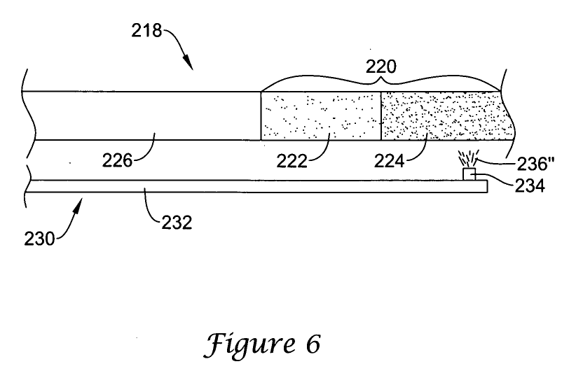

FIG. 5 depicts that after coating region 220 is defined on shaft 218 by the microdispensing of an aliphatic polyether polyurethane to define first section 222 onto shaft 218, microdispensing apparatus 230 can be used to apply additional aliphatic polyether polyurethane. This is depicted by spray 236′ of aliphatic polyether polyurethane coming from nozzle 234. This can result in second section 224 being defined as shown in FIG. 6. The resultant device is shaft 218 with coating region 220 that includes first section 222 (made from one aliphatic polyether polyurethane) and second section 224 (made from another aliphatic polyether polyurethane). Coated shaft 218 is essentially the same as shaft 18 described above. Examples of the arrangements, configurations, etc., of this device can essentially mimic what is described above.

If desired, additional microdispensing can be utilized to define additional sections. This is represented in FIG. 6 by spray 236″. The resultant device from this additional step is shaft 218 with coating region 220 that includes three sections, each coated with a different aliphatic polyether polyurethane. This coated shaft 218 is essentially the same as shaft 118 described above. Examples of the arrangements, configurations, etc., of this device can essentially mimic what is described above.

It should be understood that this disclosure is, in many respects, only illustrative. Changes may be made in details, particularly in matters of shape, size, and arrangement of steps without exceeding the scope of the invention. The invention's scope is, of course, defined in the language in which the appended claims are expressed.

What is claimed is:

1. A medical device, comprising:
an elongate shaft having a proximal portion and a distal portion;
a lubricious coating disposed over the distal portion, the coating having a first section and a second section, the first and second sections having different lubricities; and
wherein at least one of the first section and the second section includes an aliphatic polyether polyurethane.

2. The medical device of claim 1, wherein the aliphatic polyether polyurethane is capable of absorbing about 200% to about 2000% of its own weight in water.

3. The medical device of claim 1, wherein the aliphatic polyether polyurethane is capable of absorbing about 500% to about 2000% of its own weight in water.

4. The medical device of claim 1, wherein the aliphatic polyether polyurethane is capable of absorbing about 200% to about 500% of its own weight in water.

5. The medical device of claim 1, wherein both the first section and the second section include an aliphatic polyether polyurethane.

6. The medical device of claim 5, wherein the first section and the second section each include a different aliphatic polyether polyurethane.

7. The medical device of claim 5, wherein at least one of the first and second sections includes multiple layers.

8. The medical device of claim 7, wherein the multiple layers each include a different aliphatic polyether polyurethane.

9. The medical device of claim 1, wherein at least one of the first section and the second section include a radiopaque material.

10. The medical device of claim 1, wherein the lubricious coating further includes a third section having different lubricity than the first and second sections.

11. A method for manufacturing a medical device, comprising the steps of:
providing a medical device substrate;
disposing a first coating on a first portion of the substrate;
wherein the first coating includes a first aliphatic polyether polyurethane having a first lubricity;
disposing a second coating on a second portion of the substrate; and
wherein the second coating includes a second aliphatic polyether polyurethane having a second lubricity that is different from the first lubricity.

12. The method of claim 10, further comprising the step of disposing a third coating on a third portion of the substrate, wherein the third coating includes a third aliphatic polyether polyurethane having a third lubricity that is different from the first lubricity, the second lubricity, or both.

13. The method of claim 10, wherein the step of disposing a first coating on a first portion of the substrate, disposing a second coating on a second portion of the substrate, or both includes microdispensing.

14. The method of claim 10, wherein the step of disposing a first coating on a first portion of the substrate, disposing a second coating on a second portion of the substrate, or both includes inkjet printing.

15. The method of claim 10, wherein the step of disposing a first coating on a first portion of the substrate, disposing a second coating on a second portion of the substrate, or both includes dip coating.

16. The method of claim 10, wherein the step of disposing a first coating on a first portion of the substrate, disposing a second coating on a second portion of the substrate, or both includes spray coating.

17. A medical device, comprising:
an elongate shaft;
a lubricious coating disposed on the shaft, the coating having a first section, a second section, and a third section;
wherein at least two of the first, second, and third sections includes an aliphatic polyether polyurethane; and
wherein the first, second, and third sections all have different lubricities.

18. The medical device of claim 17, wherein the first, second, and third sections all include an aliphatic polyether polyurethane.

19. A medical device, comprising:
a medical device substrate;
a lubricious coating disposed on the substrate, the coating having a first section, a second section, and a third section;
wherein at least two of the first, second, and third sections include an aliphatic polyether polyurethane; and
wherein the first, second, and third sections all have different coefficients of friction.

20. The medical device of claim 20, wherein the first, second, and third sections all include an aliphatic polyether polyurethane.
